(19) United States
(12) Patent Application Publication
(10) Pub. No.: US 2015/0066631 A1
(43) Pub. Date: Mar. 5, 2015

(54) SCALABLY CALCULATING STATISTICS ASSOCIATED WITH ACTION PERFORMANCES

(71) Applicant: Google Inc., Mountain View, CA (US)

(72) Inventors: Aaron NELSON, New York, NY (US); Paul Thomas DARGA, Chicago, IL (US); Matthias BLUME, Chicago, IL (US)

(21) Appl. No.: 13/688,083

(22) Filed: Nov. 28, 2012

(51) Int. Cl. G06Q 30/02

(52) U.S. Cl. CPC G06Q 30/0246
USPC 705/14.45

(57) ABSTRACT

A method for scalably calculating statistics associated with action performances includes obtaining action performance data for one or more entities, where the action performance data comprises at least a number of times each of the one or more entities performed an action during one or more time segments, wherein the action satisfies a user specified criteria. The method also includes generating, based on the obtained action performance data, a data structure including one or more values that are organized according to a number of time segments that have elapsed between an action performance and a most recent previous action performance. Systems and machine-readable media are also provided.

### BACKGROUND

Various statistics may be obtained for action performances that are related to web resources. For example, advertisers may obtain statistics on how many unique entities have viewed an advertisement that is placed on web pages.

### SUMMARY

The subject disclosure relates generally to calculating statistics for web resources, and more particularly to calculating statistics for web resources in a scalable manner.

The subject disclosure relates to a computer-implemented method for scalably calculating statistics associated with action performances that includes obtaining action performance data for one or more entities, where the action performance data comprises at least a number of times each of the one or more entities performed an action during one or more time segments, wherein the action satisfies a user specified criteria. The method also includes generating, based on the obtained action performance data, a data structure for calculating statistics associated with the actions performed by the one or more entities. The data structure includes one or more values corresponding to numbers of actions performed by the one or more entities. The one or more values are organized into the one or more time segments during which actions corresponding to the one or more values were performed. The one or more values are further organized into one or more time segment intervals, the time segment intervals corresponding to intervals between the performed actions corresponding to the one or more values and previous action performances for the performed actions. A previous action performance for a performed action is a most recent action performance in a sequence of actions that precedes the performed action, the sequence of actions and the performed action being performed by the same entity.

The present disclosure also relates to a system for scalably calculating statistics associated with action performances that includes an action performance data obtaining module configured to obtain action performance data for one or more entities, where the action performance data comprises at least a number of times each of the one or more entities performed an action during one or more time segments, wherein the action satisfies a user specified criteria. The system also includes a data structure generation module configured to generate, based on the obtained action performance data, a first data structure for calculating statistics associated with the actions performed by the one or more entities. The first data structure includes one or more values corresponding to numbers of actions performed by the one or more entities. The one or more values are organized into the one or more time segments during which actions corresponding to the one or more values were performed. The one or more values are further organized into one or more time segment intervals, the time segment intervals corresponding to intervals between the performed actions corresponding to the one or more values and previous action performances for the performed actions. A previous action performance for a performed action is a most recent action performance in a sequence of actions that precedes the performed action, the sequence of actions and the performed action being performed by the same entity. The system further includes a user request receiving module configured to receive a user request for statistics associated with the obtained action performance data for a time interval including at least one of the one or more time segments, and a statistics calculation module configured to calculate the requested statistics based on the generated first data structure.

The present disclosure further relates to a machine-readable medium comprising instructions stored therein, which when executed by processors, cause the processors to perform operations that include obtaining one or more action performance records for one or more entities, where each of the one or more action performance records comprises at least a time at which each of the action performance records was created, a number of action performances by each of the one or more entities, and a time at which each of the action performances occurred, wherein the action performances satisfy a user specified criteria. The operations also include determining, based on the obtained one or more action performance records, whether each action performance of each entity has a corresponding previous action performance, where the previous action performance is a most recent action performance in a sequence of action performances that precedes each action performance. The operations further include identifying a time at which the previous action performance occurred, based on the obtained one or more action performance records, in a case an action performance has a corresponding previous action performance, otherwise identifying, based on the obtained one or more action performance records, a time at which an action performance record corresponding to the action performance was created. The operations yet further include organizing the number of action performances according to one or more time segments during which the action performances occurred, based on the identified time at which the previous action performance has occurred or the identified time at which the action performance record was created.

It is understood that other configurations of the subject technology will become readily apparent from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purposes of explanation, several implementations of the subject technology are set forth in the following figures.

FIGS. 1A and 1B conceptually illustrate diagrams showing example matrices for scalably calculating statistics associated with action performances.

FIG. 1C shows a diagram conceptually illustrating calculation of frequencies of various degrees based on expanded Overcount Matrices according to the subject technology.

FIG. 1D conceptually illustrates an example action performance record according to the subject technology.

FIG. 2 is a diagram of an example system for scalably calculating statistics associated with action performances.

FIG. 3 illustrates a flow diagram of an example process for scalably calculating statistics associated with action performances.

FIG. 4 conceptually illustrates an example of a system for scalably calculating statistics associated with action performances.

FIG. 5 conceptually illustrates an electronic system with which some aspects of the subject technology are implemented.

### DETAILED DESCRIPTION

In the following detailed description, numerous specific details are set forth to provide a full understanding of the present disclosure. It will be apparent, however, that the implementations of the present disclosure may be practiced without some of these specific details. In other instances, structures and techniques have not been shown in detail so as not to obscure the disclosure.

Companies that place advertisements on the internet may want to keep track of how their advertisements are viewed, and receive various statistics on the number and demographics of the advertisement views. The companies may wish to break down the statistics by various criteria. For example, the companies may wish to calculate how many unique entities (e.g., people or IP addresses) have viewed a certain advertisement at a certain website during a certain time interval. The companies may also wish to calculate how many times each unique entity viewed the advertisement on the website during the time interval. Performing calculations for such statistics using Overcount Matrices and/or expanded Overcount Matrices as discussed in more detail below, companies can be provided with such statistics in a scalable, accurate and efficient manner.

Currently, to calculate such statistics, records are kept for storing data on how many times each entity has viewed an advertisement in a given time interval. The number of unique entities who have viewed the advertisement during the time interval, and the number of times each entity has viewed the advertisement during the time interval, may both be calculated from such records. However, this approach requires keeping a separate record for each activity for each entity, which requires significant data storage capacity, as the size of the stored data increases proportionally to an increase in the number of entities that are tracked. Further, because of the amount of the data stored, significant amount of processing is also required when calculating the statistics.

To describe the various aspects of the subject technology, terms of art such as “reach” and “frequency” are used. “Reach” refers to the number of entities who have performed an action that satisfies certain criteria during a time interval. For example, if “John” viewed an advertisement three times during the month of February and Mary viewed the advertisement once, reach would have a value of “2” because two entities, “John” and “Mary,” viewed the advertisement during February. “Frequency” refers to the number of times each entity has performed an action. Frequency may also be expressed in the context of reach, such as “reach by frequency,” or “reach segmented by frequency.” In the foregoing example of John and Mary, reach, that is segmented according to frequency (reach by frequency), shows that reach with a frequency of 3 is equal to 1 (one entity, John, viewed the advertisement 3 times during the time interval), and reach with a frequency of 1 is equal to 1 (one entity, Mary, saw the advertisement once during the time interval). The term entity, as used herein, refers to an entity or machine performing the action.

Methods and systems for scalably calculating statistics associated with performance of an action (e.g., viewing an advertisement) are provided herein. Such statistics may include, for example, reach and frequency (reach segmented by frequency). Reach and frequency are calculated in a way that is scalable (e.g., in terms of number of entities for whom action performance information is provided, and in terms of the total number of action performances), incremental (e.g., processing action performance information about entities as it comes in), and that supports querying across arbitrary time intervals.

To calculate reach, an “Overcount Matrix” may be generated to help calculate reach more efficiently over arbitrary date ranges. In an Overcount Matrix, each cell contains a value representing the number of entities that perform actions that satisfy a predetermined criteria that are performed during a time segment. For example, each cell value may represent the number of entities that have viewed an advertisement for a given day. The rows of the Overcount Matrix represent the time segments (e.g., dates). The columns of the Overcount Matrix represent the number of time segments that have elapsed between the actions corresponding to the values represented in each cell, and a “previous action.” A “previous action” as used herein refers to a most recent action in a sequence of actions performed by the same entity which precedes the action corresponding to the value represented in the cell. For example, the columns of the Overcount Matrix may represent the number of days that have passed since an entity last viewed the advertisement.

Therefore, the values in each of the cells represent the number of entities who have performed “previous actions” (e.g., previous views of an advertisement by an entity) ‘n’ days ago, where ‘n’ refers to the different number of days represented by each of the columns in the matrix. The Overcount Matrix also includes a “Total” column representing the total number of entities that have performed an action during each time segment.

Data on the action performances may be stored in action performance records such as, for example, web browser cookies. An action performance record may be created for each entity to store data on the action performance (e.g., viewing an advertisement) performed by each entity and the time of each action performance. The action performance record may also store information on when the action performance record was created.

The calculation of reach and reach by frequency may be adjusted to account for “maturity” of the action performance records on which the calculations are based. The term “maturity” as used herein encompasses its plain and ordinary meaning, including, but not limited to, suitability of an action performance record for use in statistics calculation in relation to a desired time interval. For example, action performance data obtained from an action performance record that was created too recently (“immature” record) may not contain sufficient amount of data to provide accurate statistics for a desired time interval. Therefore, adjustments can be made such that only data from action performance records that were created sufficiently long ago (“mature” records) are reflected in the calculation of reach and reach by frequency.

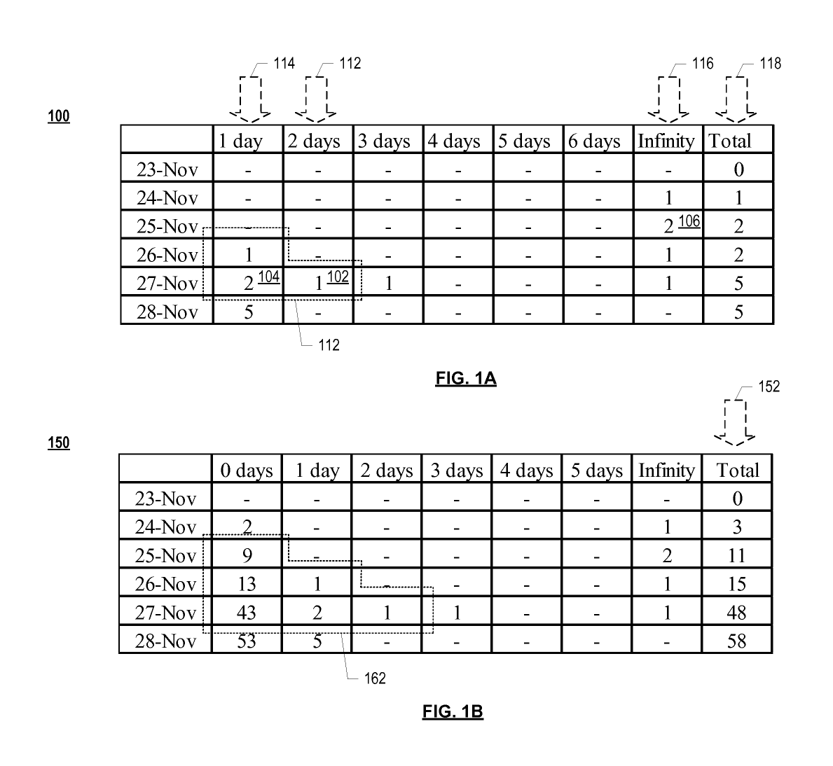

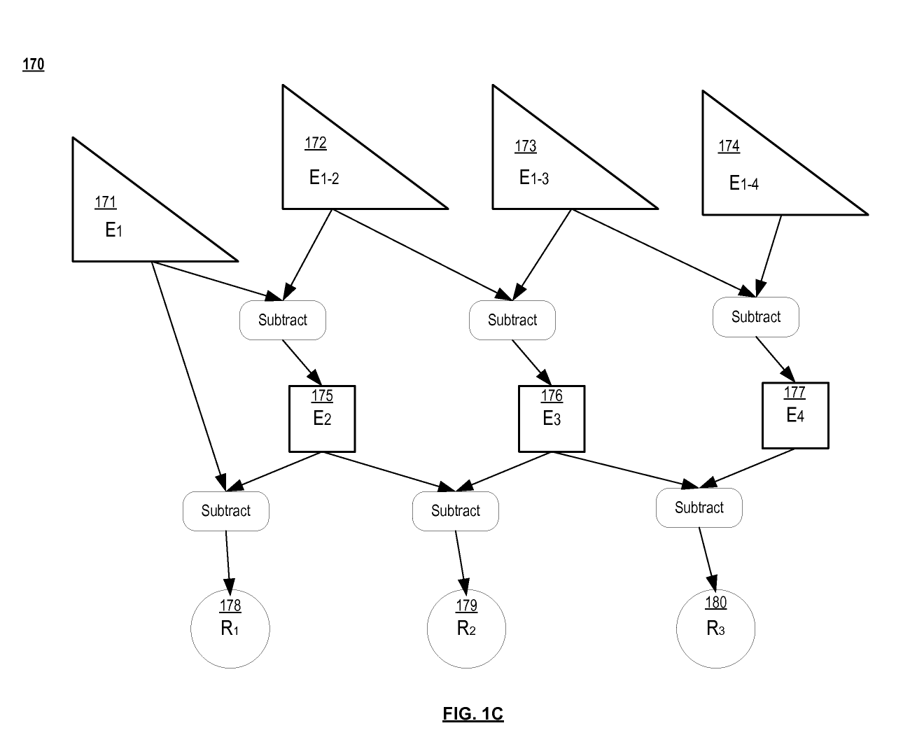

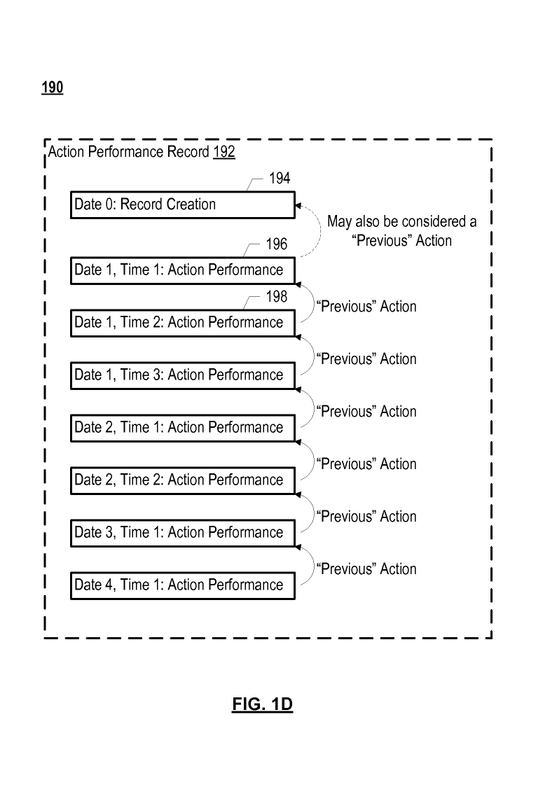

An example Overcount Matrix is described with reference to FIG. 1A. FIG. 1A shows matrix 100, which is an example Overcount Matrix 100. In the matrix 100, a value of cell 102 is 1, which represents that one entity viewed a particular advertisement on 11/27. Cell 102 is part of the “2 Days” column 112, which represents that the same entity last viewed the same advertisement two days earlier, on 11/25. The value of cell 104 is 2, which represents that two entities viewed the advertisement on 11/27, where each of the two entities last viewed the same advertisement one day ago (because cell 104 is part of the “1 day” column 114). If an entity viewed an advertisement for the very first time, it could be conventionally said that infinite number of days has elapsed since the entity last viewed the advertisement. Therefore, the value 2 in column 106 corresponds to two entities having viewed the advertisement on 11/25 for the very first time (hence column 116 is “Infinity”). The “Total” column 118 represents the number of total entities who have viewed the advertisement that day, regardless of when or whether each entity previously viewed the advertisement. In an aspect of the subject technology, the Infinity column 116 may be omitted.

Still referring to FIG. 1A, reach may be calculated by subtracting a “Triangle Sum” value from a “Total Sum” value for a time interval for which reach is calculated. The time interval may be obtained from a user. The “Triangle Sum” value is the sum of all the cells in the “Overcount Triangle” 112 for the time interval for which reach is calculated. The Overcount Triangle 112 is determined based on the length of the given time interval. The Overcount Triangle 112 is a right triangle having a height and width, each having a length calculated according to the following formula: [total length of the time interval−1]. The apex corresponding to the right angle of the Overcount Triangle 112 is located on the lower left-most cell for the time interval of interest. The “Total Sum” value is the sum of the cells in the “Total” column 118 for the time interval for which reach is calculated.

The example Overcount Matrix of FIG. 1A illustrates calculating the reach of an advertisement for the time interval 11/25-11/27. Therefore, in the example Overcount Matrix of FIG. 1A, the time interval of interest is three days, and the height and width of the triangle are two. Accordingly, reach may be calculated by subtracting the Triangle Sum value from the Total Sum value. The Total Sum value is derived by adding the values in the “Total” column 118 for the time interval 11/25-11/27 (2+2+5=9). The Triangle Sum value is derived by adding the values of the cells in the Overcount Triangle 112 (1+2+1=4). Accordingly, reach is 9-4, which is equal to 5. This value 5 represents that 5 unique entities viewed the advertisement during the time interval 11/25-11/27.

In an aspect of the disclosed technology, two or more “expanded” Overcount Matrices may be used to calculate not only reach, but also frequency (reach segmented by frequency). In a first expanded Overcount Matrix, an Overcount Matrix such as the one discussed above with reference to FIG. 1A is expanded to include a column representing the number of action performances whose previous action was performed by the same entity during the same time segment (e.g., the same day), or a “0 day column.”

In the first expanded Overcount Matrix, for example, if an entity viewed the advertisement for the very first time on Monday and viewed the same advertisement four more times during the same day, a value of 1 is added to the “Infinity” column for Monday (because the entity saw the advertisement for the very first time, and an infinite number of days has passed from when the user last saw the advertisement), and a value of 4 is added to the “0 day” column for Monday (because, beginning with the second view, the “previous view” would have occurred on the same day).

FIG. 1B shows matrix 150 which illustrates an example first expanded Overcount Matrix that is populated based on the same data as the example Overcount Matrix of FIG. 1A. Reach is calculated using the first expanded Overcount Matrix in a manner similar to the calculation described above with reference to FIG. 1A, except that an expanded Triangle Sum value is subtracted from the Total Sum value. The expanded Triangle Sum value is calculated by adding up the values of all the cells in an expanded Overcount Triangle 162. The expanded Overcount Triangle 162 is also determined in a manner similar to determining the Overcount Triangle 112 discussed above with reference to FIG. 1A, with the exception that the expanded Overcount Triangle 162 has a height and width each equal to the length of the time interval for which reach or frequency is calculated. The Total Sum value is calculated in the same manner as described above with FIG. 1A (sum of the cells in the total column for the time interval for which reach and frequency is calculated).

FIG. 1B shows calculating reach for the same time interval, 11/25-11/27, as with FIG. 1A. Reach is calculated using the first expanded Overcount Matrix in a manner similar to calculating reach using the Overcount Matrix that is discussed above with reference to FIG. 1A, the difference being that the expanded Overcount Triangle 162 is used. Therefore, reach is calculated using the first expanded Overcount Matrix using the following formula: Total Sum value (e.g., sum of the cells in the Total column 152 for the time interval) minus the expanded Triangle Sum value (sum of the cells in the expanded Overcount Triangle 162). Performing the calculation (11+15+48)−(9+13+1+43+2+1) yields the same result, 5, as with the calculation performed using the Overcount Matrix discussed above with reference to FIG. 1A.

While calculating reach using the Overcount Matrix and the first expanded Overcount Matrix provides identical results, the addition of the “0 day” column in the first expanded Overcount Matrix allows interpreting the calculated reach value in a new perspective, thereby providing a scalable method of calculating frequencies of various degrees, by performing similar calculations using additional expanded Overcount Matrices, as will be described in more detail below. Specifically, reach calculated based on the Overcount Matrix or the first expanded Overcount Matrix corresponds to the number of entities who have viewed the advertisement at least once during a time interval. However, the addition of the “0 day” column in the first expanded Overcount Matrix allows interpretation of the same reach value as the number of first action performances performed for all the entities during the time interval.

The interpretation of the reach value as the number of the first action performances, as opposed to the number of entities who have viewed the advertisement at least once, has increased significance when calculating frequencies, in addition to reach. Specifically frequencies of varying degrees (e.g., frequency of 1, frequency of 2, etc.) may be calculated in a scalable manner when values representing a number of first or second action performances, a number of first, second or third action performances and so forth, are calculated using second and third expanded Overcount Matrices, as described in the following paragraphs. In other words, the addition of the “0 day” column in the expanded Overcount Matrices allows calculation of the number of first or second action performances (using a second expanded Overcount Matrix), the number of first, second or third action performances (using a third expanded Overcount Matrix), and so forth for calculating frequencies of various degrees in a scalable manner.

Details of calculating frequencies of various degrees using the expanded Overcount Matrices follows. Frequency of 1 (number of entities who have performed the action exactly once) may be calculated using the first expanded Overcount Matrix and a second expanded Overcount Matrix (not shown). The second expanded Overcount Matrix is identical to the first expanded Overcount Matrix, with the exception that the values in each of the cells of the second expanded Overcount Matrix counts the number of actions whose “second previous actions” (second most recent action in a sequence of action performances preceding the action corresponding to the value represented in the cell; two views ago by an entity) occurred ‘n’ days ago. Performing the same calculation as discussed above for the first expanded Overcount Matrix (an expanded Triangle Sum value is subtracted from a Total Sum value) using the second expanded Overcount Matrix, the calculation would yield a value representing the number of first or second action performances.

Subtracting the number of first action performances calculated using the first expanded Overcount Matrix (e.g., matrix 150 of FIG. 1B) from the value representing the number of first or second action performances calculated using the second expanded Overcount Matrix yields the number of only the second action performances. The number of second action performances represents the number of entities who have viewed the advertisement at least two times. The number of second action performances calculated using the second expanded Overcount Matrix is subtracted from the number of first action performances calculated using the first expanded Overcount Matrix to obtain the number of entities who have viewed the advertisement exactly once: frequency of 1.

To calculate the number of entities who have viewed the advertisement exactly twice (frequency of 2), a third expanded Overcount Matrix (not shown) may be used in addition to the first and second expanded Overcount Matrices discussed above. The third expanded Overcount Matrix is similar to the first and second expanded Overcount Matrices, except that values in each of the cells of the third expanded Overcount Matrix counts the number of actions whose “third previous actions” (third most recent action in a sequence of actions preceding the action corresponding to the value represented in the cell; two views ago by an entity) occurred ‘n’ days ago.

The third expanded Overcount Matrix is used to calculate a value representing the number of first, second or third action performances, based on the same formula for calculating reach using the first and second expanded Overcount Matrices: Total Sum value (sum of the cells in the Total column for the time interval) minus the expanded Triangle Sum value (sum of the cells in the expanded Overcount Triangle). The number of third action performances (number of entities who have viewed the advertisement at least three times) is calculated by subtracting the value representing the number of first or second action performances from the value representing the number of first or second or third action performances. From this number, the number of entities who have viewed the advertisement exactly twice may be calculated (frequency of 2).

FIG. 1C shows diagram 170 conceptually illustrating calculation of the frequencies of various degrees based on the expanded Overcount Matrices. Specifically, diagram 170 illustrates calculating frequencies of 1, 2 and 3 using first, second third and fourth Overcount Matrices. The values E₁ 171, E₁₋₂ 172, E₁₋₃ 173 and E₁₋₄ 174 represent values calculated using the first, second, third and fourth expanded Overcount Matrices, respectively, using the methodology as discussed above. In other words, E₁ 171 represents the number of first action performances, E₁₋₂ 172 represents the number of first or second action performances, E₁₋₃173 represents the value of first, second or third action performances, and E₁₋₄ 174 represents the value of first, second, third or fourth action performances.

Subtracting E₁ 171 from E₁₋₂ 172 yields E₂ 175, representing the number of second action performances. The number of entities who have performed an action exactly twice is represented by R₁ 178, calculated by subtracting E₁ 171 from E₂ 175. Similarly, E₃ 176 represents the number of third action performances, and is calculated by subtracting E₁₋₂ 172 from E₁₋₃ 173. The number of entities who have exactly performed an action two times, R₃ 179, is calculated by subtracting E₂ 175 from E₃ 176. Subtracting E₁₋₃ 173 from E₁₋₄ 174 yields E₄ 177, representing the number of fourth action performances. The number of entities who have performed an action exactly three times is calculated by subtracting E₃ 176 from E₄ 177.

By following the foregoing methodology, frequency of any natural number ‘k’ (e.g., the number of entities who have viewed the advertisement exactly ‘k’ times) may be calculated. For example, a frequency of 3 may be calculated using first to 4th expanded Overcount Matrices, or a frequency of 10 may be calculated using first to 11th expanded Overcount Matrices.

In an aspect of the subject technology, as action performance data (e.g., information on number of advertisement views sorted according to dates and unique entities) for different entities becomes available, the expanded Overcount Matrices may be generated such that frequency is calculated on demand for up to a predetermined value of frequency. For example, first to 16th expanded Overcount Matrices may be generated and kept up to date with the latest action performance data such that frequency may be calculated on demand for up to frequency of 15.

The action performance data may be stored in action performance records such as, for example, web browser cookies, at each entity's client terminal (e.g., mobile computing device, laptop computer, or desktop computer). The action performance records may be created and stored upon authorization from the entity. The system according to the subject technology may obtain the stored action performance data, upon authorization from the entity, for use as input for the various expanded Overcount Matrices for calculating reach and frequency.

The action performance records may not have been in existence long enough to store sufficient amount of action performance data for calculating accurate reach or frequency for a time interval desired by a user. For example, a web browser cookie (an action performance record) may have been created in the middle a desired time interval such that data stored in the action performance record does not reflect accurate counts of each entity's action performance for the entire duration of the desired time interval.

Specifically, action performance records such as web browser cookies may be deleted every 24 hours, for privacy concerns. In such case, at any point in time, the web browser cookies would have been in existence for, at most, 24 hours. Therefore, the cookies may, at most, contain data on action performances for only the preceding 24 hours. If a user requests statistics for a time interval which spans for more than the preceding 24 hour period, the cookies would be “immature” for the desired time interval, and would not provide accurate statistics. If statistics for only the preceding 24 hour period are desired, the cookies would be “mature” and would provide accurate statistics.

Therefore, in order to improve the accuracy of the calculated statistics, the calculations of the various statistics (e.g., reach or frequency) described above with reference to FIG. 1B may be adjusted to account for the maturity of action performance records containing the action performance data on which the statistics calculations are based. For example, the calculations may be adjusted such that the calculated statistics only reflect data from mature action performance records (e.g., web browser cookies that were created before the start time of a desired time interval).

To account for the maturity of the action performance records from which action performance data is obtained (e.g., ensure that only the view counts from mature web browser cookies are included in the calculation), the creation of the action performance record (e.g., creation of a web browser cookie) may also be considered as an “action performance” for all purposes of calculating reach and frequency that is discussed with reference to FIG. 1B above. For example, when populating an expanded Overcount matrix such as the expanded Overcount matrix 150, if an action performance record indicates that the record was created on 11/25 and an action was performed by an entity for the very first time on 11/26, the very first action performance on 11/26 would be considered to have a previous action on 11/25, even though the entity has not performed an action on 11/25.

If the creation of the action performance record is considered an action performance when populating the expanded Overcount matrix, applying the same formula as the one used in the calculation discussed with reference to FIG. 1B, namely, Total Sum value−Triangle Sum value, yields a value corresponding to reach which accounts for record maturity. Specifically, the values from immature action performance records would be included in both the Total Sum value and the Triangle Sum value, thereby cancelling each other out. Therefore, the resulting value for reach would only reflect data from mature action performance records, thereby providing a more accurate calculation of statistics for a desired time interval. Second to (k+1)^{th} expanded Overcount matrices may also be populated by treating the creation of action performance records as action performances, to calculate the different frequencies as discussed with reference to FIG. 1B, that accounts for record maturity.

FIG. 1D shows a diagram 190 conceptually illustrating an example action performance record 192. The action performance record 192 includes an entry 194 corresponding to the creation of the action performance record 192. The action performance record 192 also stores various entries for action performances that an entity has performed. For example, entry 196 corresponds to the first action that the entity has performed since the creation of the action performance record 192, and entry 198 corresponds to the second action performance. For the purposes of accounting for record maturity as discussed above, entry 194 (creation of the action performance record 192) may be considered as an action performance. It follows that entry 194 can also be considered as a previous action of entry 196, and as a second previous action of entry 198.

The foregoing description discusses calculating reach and frequency associated with occurrence of a specific type of action that an entity may perform—“an entity viewing an advertisement.” However, the subject technology may also be used to calculate the number of action performances of other types of actions, such as entities accessing a web site, or cars passing through a point on the road.

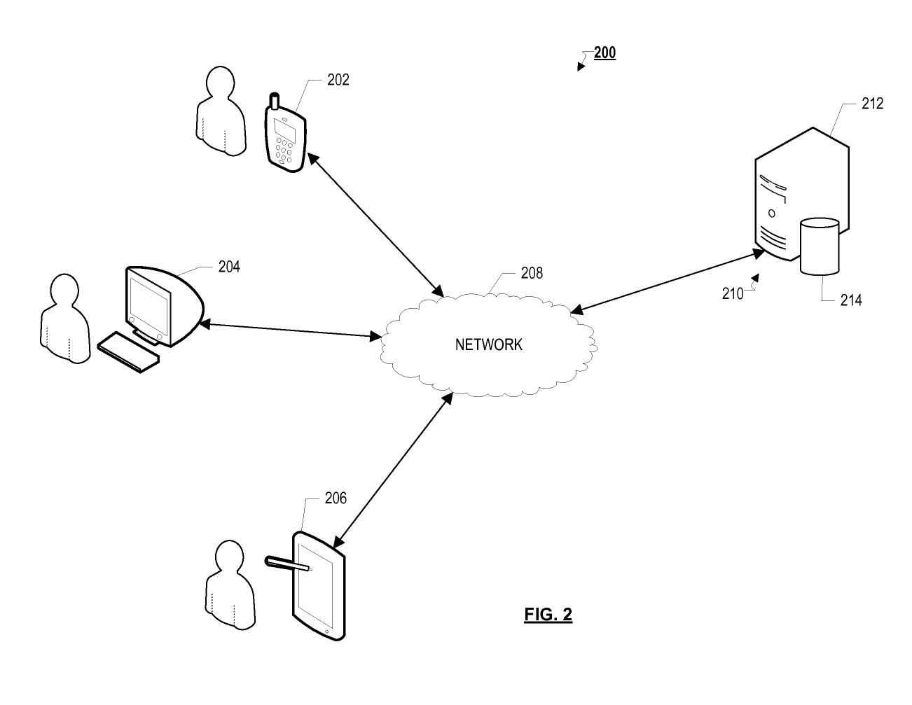

FIG. 2 illustrates an example client-server network that provides for scalably calculating statistics associated with action performances. A network display 200 includes a number of electronic devices 202, 204 and 206 communicably connected to a server 210 by a network 208. Server 210 includes a processing device 212 and a data store 214. Processing device 212 executes computer instructions stored in data store 214, for example, instructions for obtaining action performance data for one or more entities, where the action performance data comprises at least a number of times each of the one or more entities performed an action during one or more time segments, wherein the action satisfies a user specified criteria. The processing device 212 also executes instructions for generating, based on the obtained action performance data, a first data structure for scalably calculating statistics associated with the actions performed by the one or more entities.

Data store 214 may store information pertaining to, for example, action performance records storing the action performance data and/or the first data structure. Server 210 may host an application within which some of the processes discussed herein are implemented. In some example aspects, electronic devices or client devices, as used interchangeably herein, 202, 204 and 206 can be computing devices such as smartphones, PDAs, portable media players, tablet computers, televisions or other displays with one or more processors coupled thereto or embedded therein, or other appropriate computing devices that can be used for running a mobile application.

Electronic devices 202, 204 and 206 may have one or more processors embedded therein or attached thereto, or other appropriate computing devices that can be used for accessing a host, such as server 210. In the example of FIG. 2, electronic device 202 is depicted as a smartphone, electronic device 204 is depicted as a television, and electronic device 206 is depicted as a tablet computer. A client is an application or a system that accesses a service made available by a server which is often (but not always) located on another computer system accessible by a network. Some client applications may be hosted on a website, whereby a browser is a client. Such implementations are within the scope of the subject disclosure, and any reference to client may incorporate a browser and reference to server may incorporate a website.

The system (e.g., hosted at any of electronic devices 202, 204, 206 or server 210), obtains action performance data for one or more entities, wherein the action performance data comprises at least a number of times each of the one or more entities performed an action during one or more time segments, wherein the action satisfies a user specified criteria. The action satisfying the user specific criteria may include, for example, a person accessing or otherwise interacting with user-specified web resource within a user-specified time frame. The user-specified web resource may be an advertisement that is embedded in a web page. The system also generates, based on the obtained action performance data, a first data structure. The first data structure may represent, for example, a matrix or a table.

The first data structure includes one or more values corresponding to a number of actions performed by the one or more entities during each of the one or more time segments, wherein the one or more values are organized according to a plurality of categories corresponding to a number of time segments that have elapsed between the performed action corresponding to the one or more values and a most recent action in a sequence of actions preceding the performed action corresponding to the one or more values. The performed action corresponding to the one or more values and the preceding actions satisfy the user specified criteria, and are performed by the same entity.

The system may also receive a user request for statistics associated with the obtained action performance data for a time interval including at least one of the one or more time segments and calculate the requested statistics based on the generated first data structure. The users may interact with the system with any of the electronic devices 202, 204 or 206. Data pertaining to the action performance data and/or the first data structure may be stored, for example, in data store 214.

Each electronic device 202, 204 and 206 may be a client device or a host device. In some example aspects, server 210 can be a single computing device such as a computer server. In other implementations, server 210 can represent more than one computing device working together to perform the actions of a server computer (e.g., cloud computing). The server 210 may host the web server communicationally coupled to the browser at the client device (e.g., electronic devices 202, 204 or 206) via network 208.

The network 208 can include, for example, any one or more of a personal area network (PAN), a local area network (LAN), a campus area network (CAN), a metropolitan area network (MAN), a wide area network (WAN), a broadband network (BBN), the Internet, and the like. Further, the network 208 can include, but is not limited to, any one or more of the following network topologies, including a bus network, a star network, a ring network, a mesh network, a star-bus network, tree or hierarchical network, and the like.

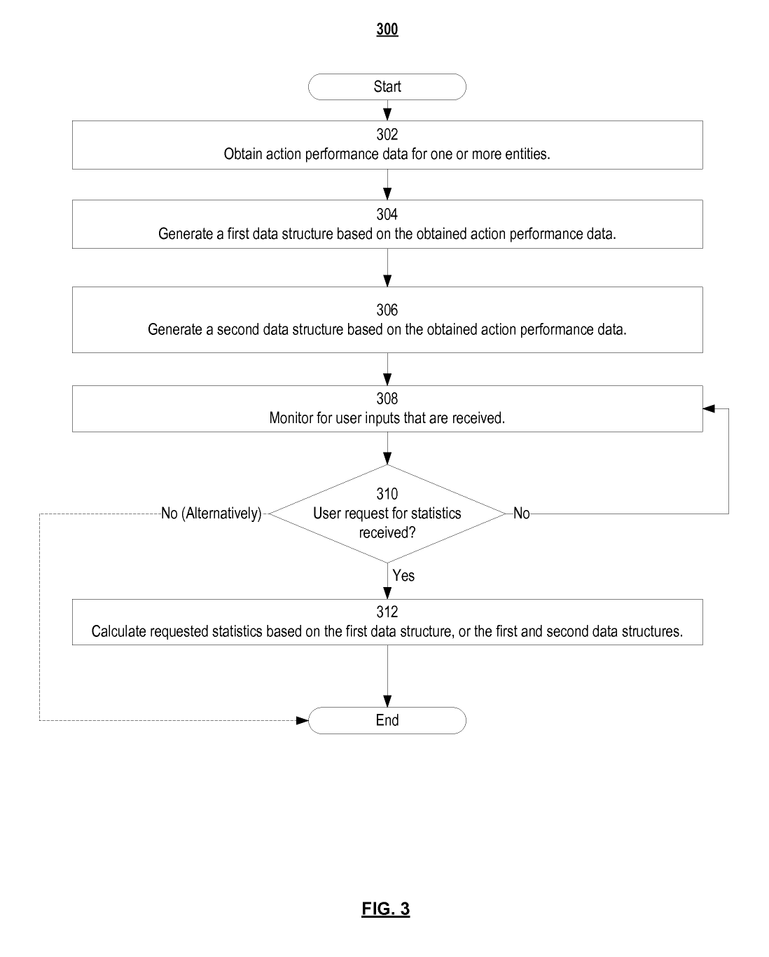

FIG. 3 illustrates a flow diagram of an example process 300 for scalably calculating statistics associated with action performances. Process 300 begins and at block 302, the system obtains action performance data for one or more entities. The action performance data includes at least a number of times each of the one or more entities performed an action during one or more time segments, where the action satisfies a user specified criteria. The entities may be, for example, persons, devices, or IP addresses. The action that is performed by an entity may be, for example, viewing web resource (e.g., an advertisement included in a web page). Whether an entity has performed an action may be determined based on, for example, a click or a touch on the advertisement.

The action performance data may be stored in action performance records (e.g., action performance record 192) at electronic devices (e.g., electronic devices 202, 204 or 206) of entities performing the actions. The action performance record for an entity may store a log of each action performance by the entity and information on the time and date of the action performance. The action performance record may also store the creation date of the action performance record. The action performance record may be, for example, a web browser cookie. For example, when a person uses a mobile web browser on a smart phone to view an advertisement that may be included in a web page, a web browser cookie may be created or updated to reflect the person's view of the advertisement.

At block 304, the system generates a first data structure based on the action performance data for the one or more entities obtained at block 302. The first data structure includes one or more values corresponding to a number of actions performed by the one or more entities during each of the one or more time segments. For example, the first data structure may be a table or a matrix where each row represents different time segments (e.g., dates) and each cell represents number of actions performances of all entities for which action performance data is obtained at block 302 during the time segment corresponding to the row of the cell.

The values of the first data structure are also organized according to a plurality of columns corresponding to a number of time segments that have elapsed between an action performed by an entity and a “previous action” performed by the same entity, where both the action and the previous action performed by the entity both satisfies a user specified criteria. A previous action is the most recent action that was performed in a sequence of actions that precede an action performance. For example, if a person viewed an advertisement for the very first time on Monday, once on Tuesday, and once on Wednesday, the “previous action” for the advertisement view on Tuesday would be the advertisement view on Monday, and the previous action for the view on Wednesday would be the view on Tuesday. Accordingly, for the view on Wednesday, one day would have passed since a previous action. The advertisement view on Monday would not have a corresponding previous view, because it is the very first view for the person. An action satisfying a user specified criteria may be, for example, a person viewing an advertisement during a user specified time frame.

In generating the first data structure at block 304, the system determines when an action was performed and whether a corresponding previous action exists, for each of the action performances represented in the action performance data obtained at block 302. If a previous action exists, the system also identifies the time at which the previous action was performed. Based on such determination, the values of the first data structure are populated into the appropriate row and column as described above.

In the example above, each column of the table represents the number of days that have passed since a “previous action.” Different columns may be provided that represent different number of days that have passed since a previous action. A column representing that 0 days have passed may also be provided. Therefore, the different rows of the table represent different time segments during which actions are performed by the different entities, and the different columns represent the number of days that have passed since a previous action was performed for an action performance. Accordingly, if an example cell at row “January 1” and column “2 days ago” has a value of 5, the value of 5 represents that 5 persons performed an action that satisfies a user specified criteria on January 1, where the same 5 persons each performed a previous action 2 days ago.

An example of the first data structure that is generated at block 304 may be the first expanded Overcount Matrix that is discussed above with reference to FIG. 1B.

At block 306, the system generates a second data structure based on the action performance data for the one or more entities obtained at block 302. The second data structure is similar to the first data structure generated at block 304. As with the first data structure, the second data structure includes one or more values corresponding to a number of actions performed by the one or more entities during each of the one or more time segments used for the first data structure. For example, the second data structure may be a table or a matrix in which the rows represent the same time segments as the rows of the first data structure discussed above. Each cell represents number of actions performances of all entities for which action performance data is obtained at block 302 during the time segment corresponding to the row of the cell.

The values of the second data structure are also organized according to a plurality of categories corresponding to a number of time segments that have elapsed between an action performed by an entity and a “second previous action” performed by the same entity, where both the action and the previous action performed by the entity both satisfies a user specified criteria. A second previous action is the second most recent action that was performed in a sequence of actions that precede an action performance. For example, if a person viewed an advertisement once on Monday, once on Tuesday, and once on Wednesday, the “second previous action” for the advertisement view on Wednesday would be the advertisement view on Monday. Accordingly, for the view on Wednesday, two days would have passed since a second previous action. An action satisfying a user specified criteria may be, for example, a person viewing an advertisement during a user specified time frame.

An example of the second data structure that is generated at block 306 may be the second expanded Overcount Matrix that is discussed above with reference to FIG. 1B.

At block 308, the system monitors for user inputs that are received at the system, and at block 310 determines whether the received user input is a user request for statistics associated with the action performance data. The request for the statistics may be for a time interval including at least one of the one or more time segments for which the action performance data obtained at block 302 is available. The requested statistics may be, for example, a number of unique entities that have performed an action performance that satisfies the user specified criteria at least once (e.g., number of unique entities that have viewed an advertisement; reach), or a number of unique entities that have performed the user criteria-satisfying action performance exactly for a certain number of times (e.g., number of unique entities that have viewed the advertisement for exactly ‘k’ number of times, where ‘k’ is a natural number; frequency of ‘k’).

If the user request for statistics associated with the action performance data is received, at block 312, the system calculates the requested statistics based on the first data structure generated at block 304, or the first data structure and the second data structure generated at block 306. If the user-requested statistics include reach (e.g., the number of unique entities that have performed that user criteria-satisfying action performance at least once), reach may be calculated using the first data structure. The details for calculating reach is discussed above with reference to FIG. 1B.

If the user-requested statistics include frequency of 2 (e.g., the number of unique entities that have performed the user criteria-satisfying action performance for exactly twice), frequency of 2 is calculating using both the first and second data structures. The details for calculating frequency of 2 is also discussed above with reference to FIG. 1B.

In an aspect of the subject technology, the system may also generate one or more additional data structures such that first to ‘k+1’th data structures (k is a natural number and is greater than or equal to 1) are generated for calculating a frequency of k. The first to ‘k+1’th data structures are generated following the methodology discussed above for the first and second data structures. The values of the ‘k+1’th data structure are organized according to a plurality of categories corresponding to a number of time segments that have elapsed between an action performed by an entity and a ‘k+1’th previous action performed by the same entity, where ‘k+1’th previous action is the ‘k+1’th most recent action that was performed in a sequence of actions that precede an action performance. Using the first to ‘k+1’th data structures, the system may calculate a frequency of k. The details for calculating a frequency of k is discussed above with reference to FIG. 1B.

If, at block 310, determination is made that a user request for statistics associated with the action performance data is not received, process 300 reverts back to block 308. Alternatively, process 300 may end.

Process 300 described above with reference to FIG. 3 above does not account for record maturity. In an aspect of the subject technology, process 300 may be adjusted to account for the maturity of action performance records from which action performance data is obtained. To adjust process 300 to account for the record maturity, when generating the first data structure at block 304, the creation of the action performance record is also considered as an action performance.

For example, referring to FIG. 1D, an action performance record includes an entry 194 corresponding to the creation of the action performance record, in addition to entries corresponding to the various action performances (e.g., entries 196 and 198). Therefore, in generating the first data structure at block 304, entry 194 is also considered as representing an action performance as any other entries representing action performances, even though entry 194 represents the creation date of the action performance record 192. Specifically, while the system goes through each entry in the action performance record 192 to determine whether each entry has a previous action, the system may arrive at entry 196 to determine whether entry 196 also has a corresponding previous action. Although entry 196 represents the very first action performance for the action performance record 192, instead of determining that entry 196 does not have a corresponding previous action, the system identifies entry 194 (which represents the creation of the action performance record 192), and determines that entry 194 is a previous action for entry 196. The system also identifies the time at which the action performance record 192 is created as the time at which the previous action for the entry 194 has been performed.

Block 306 may be similarly adjusted to generate a second data structure, the values of which are organized as discussed above for block 306 while considering the creation of action performance records as action performances. The remainder of process 300 may be performed without further adjustments. However, by the virtue of the above-described adjustments made for blocks 304 and 306 (considering creation of action performance records as an action performance), as discussed in detail with reference to FIGS. 1B and 1D above, the calculation at block 312 automatically cancels out the action performance data obtained from immature action performance records. Therefore, the calculation at block 312 yields statistics which accounts for record maturity and thus provides more accurate results.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing display. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

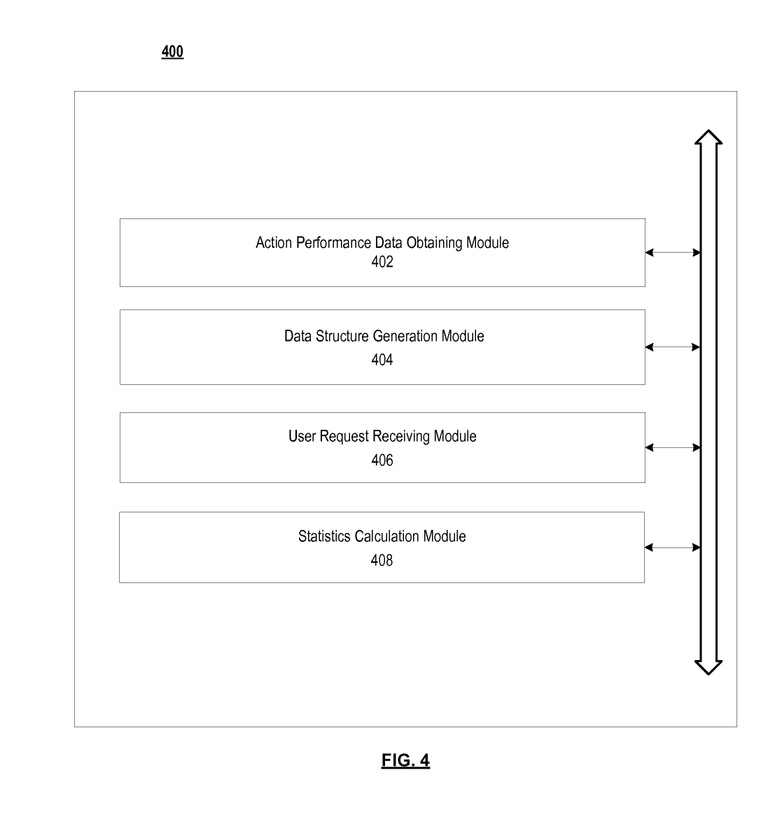

FIG. 4 illustrates an example of system 400 for scalably calculating statistics associated with action performances, in accordance with various aspects of the subject technology. System 400 includes an action performance data obtaining module 402 and a data structure generation module 404. The system may also include a user request receiving module 406 and statistics calculation module 408.

The action performance data obtaining module 402 is configured to obtain action performance data for one or more entities. The action performance data includes at least a number of times each of the one or more entities performed an action during one or more time segments, where the action satisfies a user specified criteria. The data structure generation module 404 is configured to generate a first data structure based on the action performance data obtained by the action performance data obtaining module 402. The first data structure includes one or more values corresponding to a number of actions performed by the one or more entities during each of the one or more time segments. In the first data structure generated by the data structure generation module 404, the one or more values are organized according to a plurality of categories. The categories correspond to a number of time segments that have elapsed between the performed action corresponding to the one or more values and a previous action. The previous action is the most recent action in a sequence of actions preceding the performed action corresponding to the one or more values. The performed action corresponds to the one or more values and the preceding actions satisfy the user specified criteria, and are performed by the same entity.

The data structure generation module 404 may also be configured to generate additional data structures such that first to ‘k+1’th data structures are generated (k is greater than or equal to 1). The values of the ‘k+1’th data structure are organized according to a plurality of categories corresponding to a number of time segments that have elapsed between an action performed by an entity and a ‘k+1’th previous action performed by the same entity, where ‘k+1’th previous action is the ‘k+1’th most recent action that was performed in a sequence of actions that precede an action performance.

The user request receiving module 406 may be configured to receive a user request for statistics associated with the action performance data obtained by the action performance obtaining module 402, for a time interval including at least one of the one or more time segments for which the action performance data is available. The statistics calculation module 408 may be configured to calculate the statistics for which the user request is received by the user request receiving module 406.

These modules may be in communication with one another. In some aspects, the modules may be implemented in software (e.g., subroutines and code). In some aspects, some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

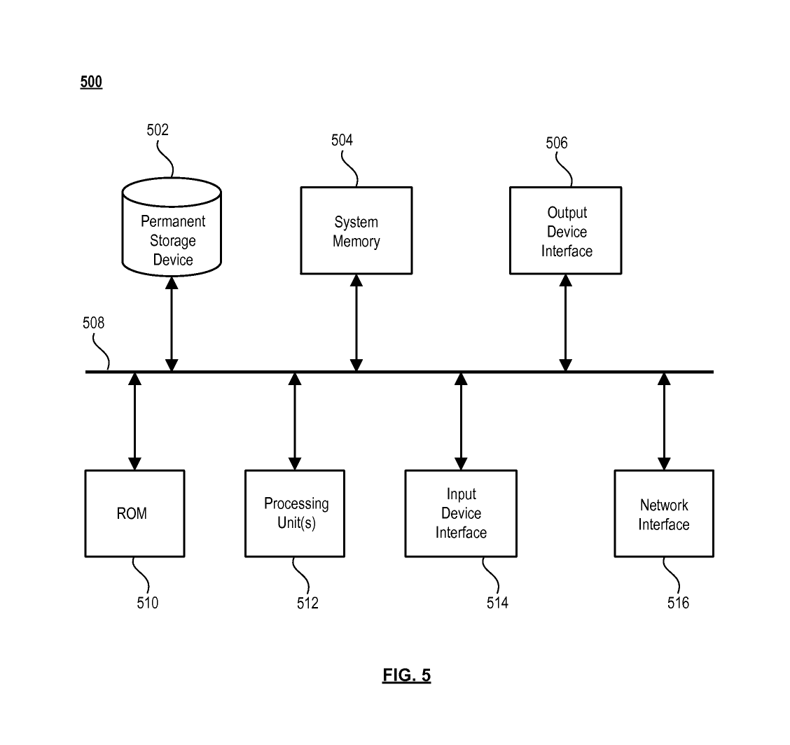

FIG. 5 conceptually illustrates an electronic system with which some aspects of the subject technology are implemented. Electronic system 500 can be a server, computer, phone, PDA, laptop, tablet computer, television with one or more processors embedded therein or coupled thereto, or any other sort of electronic device. Such an electronic system includes various types of computer readable media and interfaces for various other types of computer readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such a random access memory. System memory 504 stores some of the instructions and data that the processor needs at runtime. In some implementations, the processes of the subject disclosure are stored in system memory 504, permanent storage device 502, and/or ROM 510. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interfaces 506 enables, for example, the display of images generated by the electronic system 500. Output devices used with output device interface 506 include, for example, printers and display devices, such as televisions or other displays with one or more processors coupled thereto or embedded therein, or other appropriate computing devices that can be used for running an application. Some implementations include devices such as a touch screen that functions as both input and output devices.

Finally, as shown in FIG. 5, bus 508 also couples electronic system 500 to a network (not shown) through a network interface 516. In this manner, the computer can be a part of a network of computers (such as a local area network (“LAN”), a wide area network (“WAN”), or an Intranet, or a network of networks, such as the Internet. Any or all components of electronic system 500 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a device having a display device, e.g., televisions or other displays with one or more processors coupled thereto or embedded therein, or other appropriate computing devices that can be used for running an application, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that some illustrated steps may not be performed. Some of the steps may be performed simultaneously. For example, in certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

For situations in which the methods or systems discussed above collect personal information about entities (e.g., action performance data for one or more entities), may make use of personal information and/or may store personal information (e.g., store action performance data in a action performance record such as, for example, web browser cookies), the entities may be provided with an opportunity to control whether programs or features that may collect personal information (e.g., information about an entity's action performances such as, for example, viewing an advertisement), or to control whether and/or how to receive content from the content server that may be more relevant to the entity. In addition, certain data may be anonymized in one or more ways before it is stored or used, so that personal information is removed when generating parameters (e.g., demographic parameters or statistics related to action performance data such as, for example, reach or frequency of action performances). For example, an entity's identity may be anonymized so that no personally identifiable information can be determined for the entity, or an entity's geographic location may be generalized where location information is obtained (such as to a city, ZIP code, or state level), so that a particular location of an entity cannot be determined. Thus, the entity may have control over how information is collected about the entity and used by a content server.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “example” is used herein to mean “serving as an example or illustration.” Any aspect or design described herein as “example” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

1-10. (canceled)

11. A system for scalably calculating statistics associated with action performances, the system comprising:
an action performance data obtaining module configured to obtain action performance data for one or more entities, wherein the action performance data comprises at least a number of times each of the one or more entities performed an action during one or more time segments, wherein the action satisfies a user specified criteria;
a data generation module configured to determine, based on the obtained action performance data, a first set of one or more values corresponding to one or more time segments and a number of time segments that have elapsed between the actions corresponding to the values and a previous action, each value corresponding to a number of unique entities that performed the action during both one of the one or more time segments and also during a previous one of the one or more time segments, wherein a time segment interval is an interval between the corresponding time segment and one or more previous time segments;
a user request receiving module configured to receive a user request for the statistics associated with the performed actions by the one or more entities for a time interval including at least one of the one or more time segments; and
a statistics calculation module configured to calculate the requested statistics based on the generated first one or more values.

12. The system of claim 11, wherein the action performed by each of the one or more entities is viewing of an online content item.

13. The system of claim 11, wherein the statistics calculation module is further configured to calculate a number of the one or more entities having performed the action at least once during a time interval including at least one of the one or more time segments, based on the first set of one or more values.

14. The system of claim 11, wherein the data generation module is further configured to determine, based on the obtained action performance data, a second set of one or more values corresponding to the one or more time segments and one or more time segment intervals, the time segment intervals corresponding to intervals between the performed actions corresponding to the one or more values and second previous action performances for the performed actions, wherein a second previous action performance for a performed action is a most recent action performance in a sequence of actions that precedes the performed action, the sequence of actions and the performed action being performed by the same entity.

15. The system of claim 14, wherein the statistics calculation module is further configured to calculate a number of the one or more entities having performed the action exactly once during a time interval including at least one of the one or more time segments, based on the first set of one or more values and the second set of one or more values.

16. The system of claim 11, wherein the action performance data is obtained from client terminals associated with the one or more entities.

17. (canceled)

18. The system of claim 11, wherein the user specified criteria comprises viewing an online content item during a user specified time interval.

19. The system of claim 18, wherein viewing the online content item comprises clicking on the online content item that is displayed on a web page.

20. A machine-readable medium comprising instructions stored therein, which when executed by processors, cause the processors to perform operations comprising:
obtaining one or more action performance records for one or more entities, wherein each of the one or more action performance records with each action performance record associated with an entity from the one or more entities, and each action performance record comprising data for one or more action performances performed by the entity including date and time of each action performance;
determining, based on the obtained one or more action performance records, whether each action performance of each entity has a corresponding previous action performance, wherein the previous action performance is a most recent action performance in a sequence of action performances that precedes each action performance;
identifying a time at which the previous action performance occurred, based on the obtained one or more action performance records, in a case an action performance has a corresponding previous action performance, otherwise identifying, based on the obtained one or more action performance records, a time at which an action performance record corresponding to the action performance was created; and
organizing the number of action performances according to one or more time segments during which the action performances occurred, based on the identified time at which the previous action performance has occurred or the identified time at which the action performance record was created.

21. (canceled)

22. (canceled)

23. The system of claim 11, wherein the requested statistics include a number of times each unique entity viewed the online content item.

24. The system of claim 11, wherein the requested statistics include a number of unique entities who viewed the online content item.

25. A method for scalably calculating statistics associated with action performances, the method comprising:
storing, in a memory of a processing device, action performance records, each action performance record obtained from an electronic device and containing one or more entries, each entry comprising a date and time that the electronic device viewed an online content item;
generating, by the processing device from the action performance records, a first data structure arranged according to a set of time segments and a set of time segment intervals and comprising a plurality of values, each value corresponding to a time segment of the set of time segments and a time segment interval of the set of time segment intervals and representing a number of unique electronic devices that have a performance action record that comprises:
a first entry having a first date and time corresponding to the time segment, and
a second entry having a second date and time, wherein an interval between the second date and time and the first date and time corresponds to the time segment interval;
storing the first data structure in the memory of the processing device;
receiving, by the processing device, a request for statistics associated with action performances; and
calculating, by the processing device using the first data structure, a number of unique electronic devices that viewed the online content item during the specified time segment interval.

26. The method of claim 25, wherein each action performance record is stored in a web browser cookie on an electronic device.

27. The method of claim 25, wherein calculating the number of unique electronic devices comprises:
determining a total number of electronic devices that viewed the online content item during the first interval using the first data structure;
determining a first value by summing a first subset of values from the data structure for the first interval; and
subtracting the first value from the total number of electronic devices.

28. The method of claim 25, further comprising:
generating, by the processing device from the action performance records, a second data structure arranged according to the set of time segments and a second set of time segment intervals different from the first set of time segment intervals and comprising a second plurality of values, each value of the second plurality of values corresponding to a time segment of the set of time segments and a time segment interval of the second set of time segment intervals and representing a number of unique electronic devices that have a performance action record that comprises:
a first entry having a first date and time corresponding to the time segment, and
a second entry having a second date and time, wherein an interval between the second date and time and the first date and time corresponds to the time segment interval; and
storing the second data structure in the memory of the processing device.

29. The method of claim 28, wherein each action performance record is stored in a web browser cookie on an electronic device.

30. The method of claim 28, further comprising calculating, by the processing device using the first data structure and the second data structure, a number of electronic devices that viewed the online content exactly once during a time interval that includes at least one time segment of the set of time segments.

31. The method of claim 25, further comprising calculating, by the processing device using the first data structure, a number of times each unique electronic device viewed the online content item.

32. The method of claim 25, further comprising calculating, by the processing device using the first data structure, a number of unique electronic devices that viewed the online content item.
